(19) United States
(12) Patent Application Publication
(10) Pub. No.: US 2007/0130622 A1
(43) Pub. Date: Jun. 7, 2007

(54) Method and apparatus for verifying and ensuring safe handling of notifications

(75) Inventors: Ajay Chander, San Francisco, CA (US); Haruka Kikuchi, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: DoCoMo Communications Laboratories USA, Inc.

(21) Appl. No.: 11/602,604

(22) Filed: Nov. 20, 2006

Related U.S. Application Data
(60) Provisional application No. 60/739,076, filed on Nov. 21, 2005.

(51) Int. Cl. G06F 12/14

(52) U.S. Cl. 726/22

(57) ABSTRACT

A method and apparatus for verifying and/or ensuring safe handling of notifications. In one embodiment, the method comprises receiving a notification and handling the notification safely using program code that has a notification handler that has been statically verified to handle the notification according to a notification acceptance policy.

This application claims the benefit of and incorporates by reference U.S. Provisional Application No. 60/739,076 entitled “A Method and Apparatus for Verifying and Ensuring Safe Handling of Notifications,” filed Nov. 21, 2005.

### FIELD OF THE INVENTION

The invention is related to the field of computer program execution; more specifically, the present invention is related to the safe handling of notifications by a computer program.

### BACKGROUND OF THE INVENTION

Notification is a fundamental function of programs communicating with other programs in a networked or distributed system. To communicate change in a program's status, to establish the initial connection for server-client programs, or for other types of asynchronous communication, notification is essential. One characteristic of notifications is that they may be self-initiated by the program.

Notification support appears in programs all the way from network protocol stacks in operating systems to application programs. TCP/IP, one of the fundamental protocols for the Internet, has this functionality to enable communication among the devices connected to networks. At the application level, many instances abound, such as, for example, instant messaging (IM) and email. IM protocols require sending notifications about the availability of users to IM clients of other interested or “subscribed” users. An email may also be viewed as an application specific notification. That is, an email meant for a particular recipient is sent only to that recipient by email servers.

In the context of mobile communication, applications need to support the ability to accept notifications in order to enable true distributed applications and client-server applications. In this context, it is important that applications not miss out on notifications whose receipt is wanted, as well as protect themselves from flooding by notifications from other entities in the networked system whose receipt is not wanted.

Successful notification protocols require an agreement amongst communicating programs to behave properly and obey the rules of the protocol. If these rules are broken by any of the participating programs, various attacks (denial-of-service, spam, etc.) may result. Note that it is typically assumed that client code, such as an email reader or IM client, is trusted and will handle notifications properly. Given that some servers have selfish, revenue-related reasons to send notifications, and the complexity of writing correct software, this assumption is not well-founded.

A typical denial-of-service attack may result from computational processing at the client being diverted to handle unasked-for notifications, diverting resources away from other programs on the client. An example of this is the SYN flooding attack on the TCP protocol, which forces servers to put aside state in memory for fictitious clients fabricated by the attacker, thus leading to a denial-of-service on the server. At the application level, a denial-of-service attack may be more egregious as it can request the user's input on each notification. Flooding the user with unwanted notifications essentially renders their computational device useless. Several viruses, spam engines, and malicious scripts and applets use such denial-of-service attacks to frustrate end-users completely. There are two essential components of a denial-of-service attack: first, too many notifications are sent, and second, these are not notifications in which the client is interested.

Some scripting languages do not provide the ability to accept notifications, thus solving the problem by eliminating all the benefits. Clearly, this is not an acceptable solution, as notifications are identified as an essential and useful component of some systems with communicating programs.

By using session authentication and encrypting notifications sent from servers, it is possible to ensure that notifications are handled by client code that originates from trusted parties. A drawback of this approach is that it assumes that the code originating from the trusted party handles the notifications safely, without any verifiable proof of the same.

Typed environments that match application logic to typed events are helpful for developers in avoiding simple mistakes in event handling. However, such techniques do not look beyond type matching, and ignore the behavior of client code, specifically under what conditions it handles notifications. In addition, they do not provide any functionality to instrument unsafe client code.

The Business Process Execution Language (BPEL) defines a XML-based meta-programming language for composing web services. BPEL was written by developers from BEA Systems of San Jose, Calif., IBM of Poughkeepsie, N.Y. and Microsoft Corporation of Redmond, Wash. An execution engine for BPEL is also provided. As a programming language, BPEL provides both procedural and event-driven programming capabilities. Thus, server instances can be composed by BPEL if the services provided by servers are available as web services. While BPEL provides an extensive specification for web services, it doesn't provide any methodology to ensure the safe handling of notifications.

### SUMMARY OF THE INVENTION

A method and apparatus for verifying and/or ensuring safe handling of notifications. In one embodiment, the method comprises receiving a notification and handling the notification safely using program code that has a notification handler that has been statically verified to handle the notification according to a notification acceptance policy.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a system for verifying and ensuring the safe handling of notifications.

FIG. 2 illustrates an architectural description of the main communication pathways and components in a system that may generate notifications.

FIG. 3 shows a system in which all notification handlers are part of the client domain.

FIGS. 4 through 6 show some possible modes of communication between clients and servers that relate requests to notifications

FIG. 5 illustrates a notification in response to a client-initiated request with a different recipient.

FIG. 6 illustrates inter-server processing of requests.

FIG. 7 illustrates a consumer's process for verifying a client NAPs generated by 3^{rd} parties.

FIG. 8 illustrates one embodiment of a process for statically verifying a NAP.

FIGS. 9 and 10 show the execution tree, and the portion of it that handles the computation of the update predicate, for an example of a client notification handler code.

### DETAILED DESCRIPTION OF THE PRESENT INVENTION

A method and apparatus for ensuring the safe handling of notifications is disclosed.

For purposes herein, the following definitions apply:

notifications—any information sent from other programs (referred to herein as “servers” for convenience) to a program, including such information sent at their own initiation. Some examples of notifications include, but are not limited to, advertisements, stock updates, local weather, news, etc.

handling—refers to a program executing locally on a machine (referred to herein as “client” for convenience) that handles the notification sent by the server.

safety—refers to a client program following the client's safety policy for handling notifications. In one embodiment, this safety policy specifies the exact conditions under which a notification must or must not be handled by the client. In one embodiment, the safety policy also indicates how the client program is to handle the notification. In other words, the safety policy can specify exactly what desired and undesired notifications are. By ensuring that notifications are handled safely, clients can be protected from denial of service attacks from malicious or buggy server programs that flood clients with unwanted notifications.

flexible—refers to the technique applying to all sequential computer programs.

efficient—refers to the fact that the technique expends significantly less computation ensuring the safety of notification handling at runtime.

In one embodiment, the technique involves specifying notifications as first class data objects with a specification that describes how they may be computed upon, and how they may be used in policies. In one embodiment, the client's safety policy is specified as a Notification Acceptance Policy (NAP), which statically verifies whether the client notification handler respects the client's NAP. For certain classes of safety policies, the client notification handler is dynamically instrumented to ensure conformance with the client's NAP. The method also includes a policy verification mechanism that may be used by a client to verify NAPs produced by untrusted sources.

Techniques described herein focus on solving the problem of efficiently determining if notifications are handled safely by client code. The notion of safety herein encompasses handling notifications exactly when such handling is permitted by a client side safety policy, referred to herein as the Notification Acceptance Policy (NAP). These techniques also verify NAPs written by untrusted parties.

In one embodiment, the techniques described herein provide a verifiable guarantee regarding the behavior of client notification handling code, rather than guaranteed statements about its origin. As a result, these techniques allow for client notification handling programs to be written by untrusted 3^{rd} party developers.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc. Overview

Techniques for ensuring safe handling of notifications by clients, using static verification and/or dynamic instrumentation are described. Clients are notification consumers, and a technique described herein can prevent against attacks resulting from a violation of the client's safety policy, such as denial-of-service attacks.

A technique described herein involves specifying notifications as first class data objects with a specification that describes how they may be computed upon, and how they may be used in policies. In one embodiment, the client's safety policy is specified as a Notification Acceptance Policy (NAP), which statically verifies whether the client notification handler respects the client's NAP. For certain classes of safety policies, the client notification handler is dynamically instrumented to ensure conformance with the client's NAP. A method described herein also includes a policy verification mechanism that may be used by a client to verify NAPs produced by untrusted sources.

In one embodiment, the method comprises receiving a notification and handling the notification safely using program code that has a notification handler that has been statically verified to handle the notification according to a notification acceptance policy and has been dynamically instrumented with dynamic checks to conform to the notification acceptance policy if the program code, prior to receiving the notification, was determined to be unable to handle notifications safely.

In one embodiment, the notification is sent from a server to the client executing the program code that has the notification handler. In one embodiment, the notification in sent in response to a request from a client executing the program code. In another embodiment, the notification in sent in response to a request from a first client that is different from a second client executing the program code. In yet another embodiment, the notification in sent in response to an inter-server communication.

In one embodiment, the notification is specified as a first class data object. In one embodiment, this first class data object includes a specification indicating how this data object may be computed and how this data object may be used in a policy in the notification policy.

In one embodiment, the notification acceptance policy is specified algebraically. In another embodiment, the notification acceptance policy specifies that the handler processes the notification based on its type and a policy predicate. The policy predicate may be constructed from policy constructors specified in a specification for the notification with the same notification type. In one embodiment, the notification acceptance policy is specified by a consumer of the notifications.

In one embodiment, the notification acceptance policy is generated by another party, and the method also comprises verifying the notification acceptance policy prior to its use in handling the notification. In one embodiment, verifying the notification acceptance policy includes generating one or more policies using a notification specification and using a natural language description of policy descriptors to describe how the notification acceptance policy would operate.

In one embodiment, the method also includes performing static verification of the program code corresponding to the handler. The static verification is performed in accordance with a notification acceptance policy. In one embodiment, static verification is performed by generating an execution tree for the program code, where nodes in the execution tree correspond to individual commands in the program code, and computing an update predicate for portions of the program code in which notifications are accessed.

In one embodiment, the method also includes checking a notification handler in the program code for safety compliance with the notification acceptance policy.

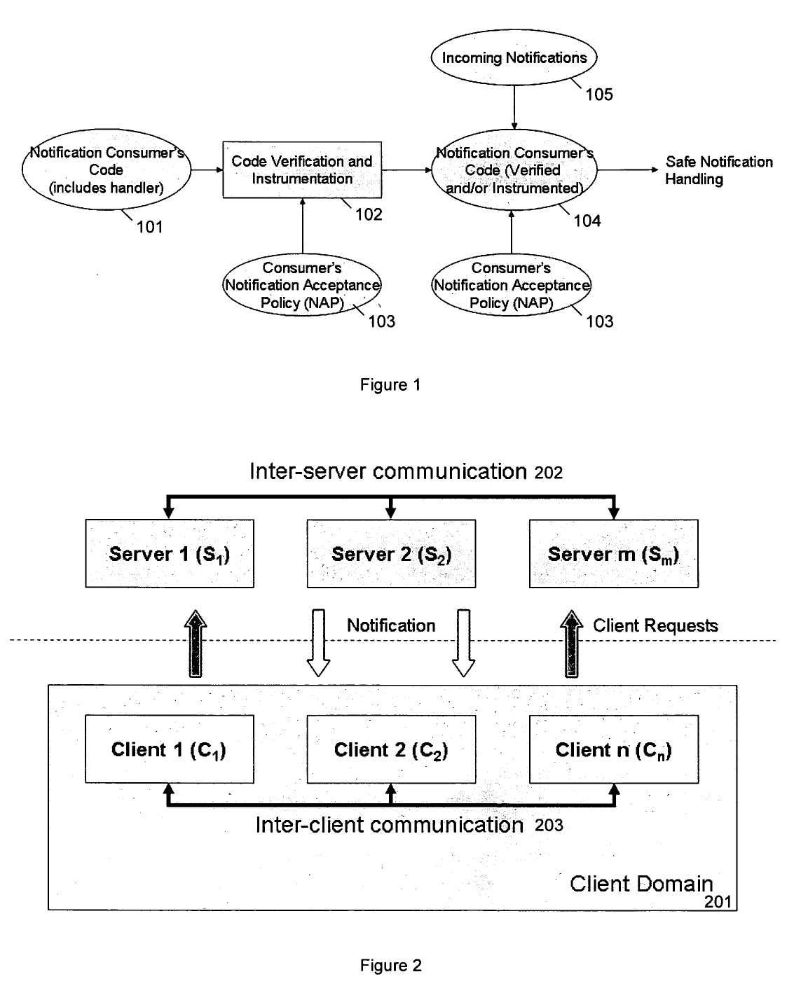

FIG. 1 is a block diagram of one embodiment of a system for verifying and ensuring the safe handling of notifications. In order to ensure that the client handles notifications safely as expressed in a notification acceptance policy (NAP), the system performs a verification process on the client code. As a result of this verification, the system either rejects the code, verifies the code as safe, or instruments the code with dynamic checks to ensure safety. This resultant verified or instrumented code is then executed, and is guaranteed to process notifications safely.

Referring to FIG. 1, consumer code 101, which includes a notification handler, is input to code verification and instrumentation unit 102, along with consumer notification acceptance policy (NAP) 103. In one embodiment, consumer code 101 operates as a notification consumer, and its handler handles notifications, such as incoming notifications 105. In one embodiment, incoming notifications 105 are generated by servers, with each server generating a notification according to some notification specification. NAP 103 specifies, for each notification consumer, the set of conditions under which the notification may be handled. In one embodiment, NAP 103 specifies desirable notifications, undesirable notifications, or both. In another embodiment, NAP 103 also specifies how the notifications should be handled by consumer code 101.

In response to consumer code 101 and consumer notification acceptance policy (NAP) 103, code verification and instrumentation unit 102 performs verification on consumer code 101, and may perform instrumentation on consumer code 101 depending on the results of the verification process. The verification and instrumentation processes are performed by processing logic in code verification and instrumentation unit 102, which may comprise hardware (circuitry, dedicated logic, etc.), software (such as is run on a general purpose computer system or a dedicated machine), or a combination of both.

In one embodiment, as a result of this verification, code verification and instrumentation unit 102 may either reject consumer code 101, verify consumer code 101 as safe, or instrument consumer code 101 with dynamic checks to ensure safety. The resultant verified or instrumented consumer code 104 is then executed, and received incoming notifications 105 and the consumer's NAP 103 and, in response to these inputs, is guaranteed to process notifications safely.

As described below, the techniques disclosed here for safe notification handling provide a uniform framework for specifying notifications, NAPs, and provide mechanisms for checking the behavior of client handler code for safety compliance with the NAP. In one embodiment, the techniques described herein are independent of the languages used for client computation, and can be extended to cover other specification languages for notifications 105 and for NAP 103, beyond the exemplary ones presented herein.

An Example of a System Architecture

FIG. 2 illustrates an architectural description of the main communication pathways and components in a system that may generate notifications. Referring to FIG. 2, a set of m servers S₁, S₂, . . . , Sₘ and a set of n clients C₁, C₂, . . ., Cₙ communicate with each other and amongst themselves. Servers S₁, S₂, . . . , Sₘ communicate with each other using inter-server communication paths (e.g., interconnect, bus, network, etc.) 202, while clients C₁, C₂, . . . , C₁-communicate with each other using inter-client communication paths (e.g., interconnect, bus, network, etc.) 203 (which is in client domain 201). A notification, in the form of a message, is sent from one of servers S₁, S₂, . . . , Sₘ to at least one of clients C₁, C₂, . . . , Cₙ, in the context of an end application (i.e., any application on the client that has an understood communication protocol with the server, e.g., email, incoming phone call, instant messaging, TCP stack, etc.). Thus, each client acts as a notification handler for one or more servers. Clients C₁, C₂, . . . , Cₙ send requests to servers S₁, S₂, . . . , Sₘ.

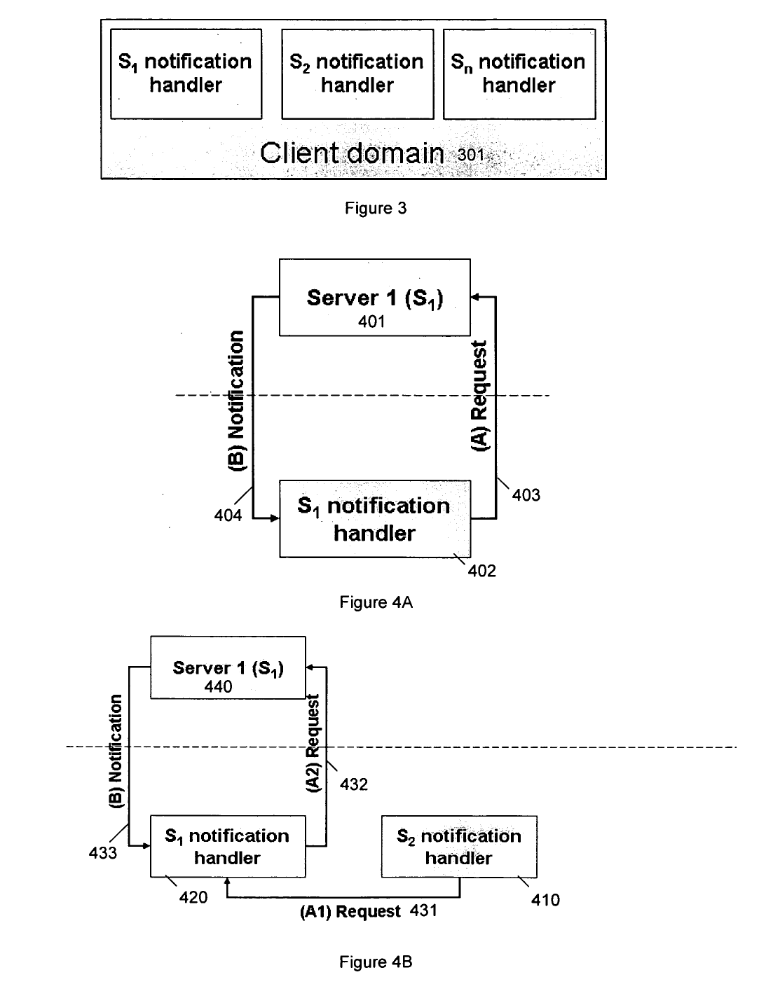

In one embodiment, all notification handlers are part of the client domain, as shown in FIG. 3. Referring to FIG. 3, the S₁ notification handler, S₂ notification handler, and Sₙ notification handler are part of client domain 201. Note that the definition of a server and client is somewhat arbitrary and a machine may act as a server for one application and as a client for another.

FIGS. 4 through 6 show some possible modes of communication between clients and servers that relate requests to notifications. FIGS. 4A and 4B illustrate notifications that are made in response to client-initiated requests. Referring to FIG. 4A, a server 401 sends a notification 404 in response to a request 403 from a client's notification handler 402. Request 403 may be a response to an event generated by another client, and communicated via inter-client communication mechanisms. This is shown in FIG. 4B, wherein a notification handler of client 410 sends a request 431 to a notification handler of client 420 using an inter-client communication path (e.g., interconnect, bus, network, etc.). In response, client 420 sends request 432 to server 440. In response to request 432, server 440 sends notification 433 to client 420, where its notification handler handles notification 433.

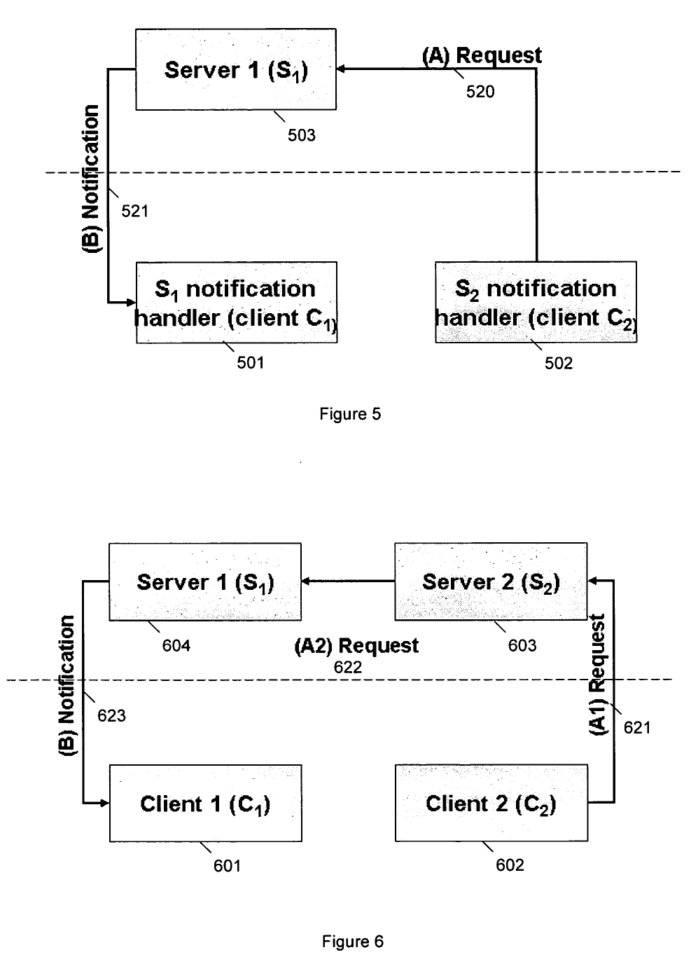

FIG. 5 illustrates a notification in response to a client-initiated request with a different recipient. Referring to FIG. 5, a client 502 sends a request 520 to server 503, which then sends a related notification 521 to a different client, namely client 501.

FIG. 6 illustrates inter-server processing of requests. In such a case, the final notification to a client may come from a different server than the one that the original request was sent to. Referring to FIG. 6, client 602 sends a request 621 to server 603. In response to request 621, server 603 sends request 622 to server 604. Request 622 may include all or a portion of request 621. In response to request 622, server 604 sends the appropriate notification 623 to client 601. Note that clients 601 and 602 may be the same client.

There are a number of ways to specify notifications and the NAP, examples of which are given below.

Examples of Notification Specifications

A notification belongs to a notification type. In one embodiment, the specification of notification types has an algebraic nature for the functional part and an abstract data type nature for the data portion. In one embodiment, a notification specification includes the following: the name of the type, the set of functions that can operate on notifications of this type, a set of base notification objects that belong to the notification type; and a set of axioms that can be used to reason about notifications of this type. In one embodiment, the name of the type is a unique ID in the namespace in which the type is being processed. Various implementation methods for enforcing unique names can be used here.

In one embodiment, the set of functions that can operate on notifications of this type are the only functions that can operate on notifications of this type. In one embodiment, these functions comprise data constructors, computational functions, and policy constructors. A data constructor has a return type that is the same as the type of the notification of which it is part, and it is used to construct new notifications of this type. A computational function takes a notification of this type specification as one of its arguments. A policy constructor describes predicates that can be used by clients to restrict the processing of notifications of this type. In one embodiment, the predicate in a policy constructor can refer to any portion of the notification specification, and can use the boolean connectives AND, OR, or NOT, as well as the equality construct. In one embodiment, the policy constructor also contains a natural language description of what the intended restriction expressed by the policy is, which can later be used for verification by notification consumers.

An Example of a Client Notification Acceptance Policy (NAP) Specification

In one embodiment, the client NAP is of the form Policy Predicate P [symbol] {Server S, Notification Type Nₜ, Client Notification Handler C} The above policy specifies that notification handler code C will process a notification of type Nₜ coming from server S if and only if policy predicate P is true. In one embodiment, weaker notions of the above NAP, that restrict the notification to “if” (1) or “only if” (2) are used.
(1)Policy Predicate P [symbol] {Server S, Notification Type Nₜ, Client Notification Handler C}
(2)Policy Predicate P [symbol] {Server S, Notification Type Nₜ, Client Notification Handler C}

Note that arrows above imply that the policy predicate P implies ( [symbol] ) or is implied by ( [symbol] ) the server S, notification type Nₜ, and the client notification handler C. In one embodiment, the policy predicate P can only be constructed from policy constructors mentioned in the specification for the notification type Nₜ.

An Example of a Language Specification

One embodiment of a language is presented herein using examples and instances of the general techniques instantiated to this language.

Literal := Var | Const
Var := a, b, c, ... (an infinite list of symbols)
Const := collection of constants from data type specifications in the
language, such as 0, 1, ...
VarList := Var+
LiteralList := Literal+
Term := Literal | fₜ(LiteralList) where fₜ is a function of the correct
arity in the corresponding
data type specification
Cmd := Var [symbol] Term

| if BoolCond then Cmd else Cmd
| Cmd; Cmd
| defn f (VarList) [Cmd]
| f (LiteralList)
| process_notif

BoolCond := fₜ(Literal)

| BoolCond and BoolCond
| BoolCond or BoolCond
| not BoolCond

The main points of the above definition follow a standard language definition format, where data types have been specified algebraically, in order to specify that functions that can act on elements of that data type. The special command process_notif is an abstraction of the point in client notification handler code when an incoming notification is processed. In one embodiment, the function fₜ in the above definition can be any function in the corresponding data type (or notification type) specification, and does not have restrictions on it as opposed to functions that appear in client NAPs.

An Example of a Process for Verifying Policy Generation

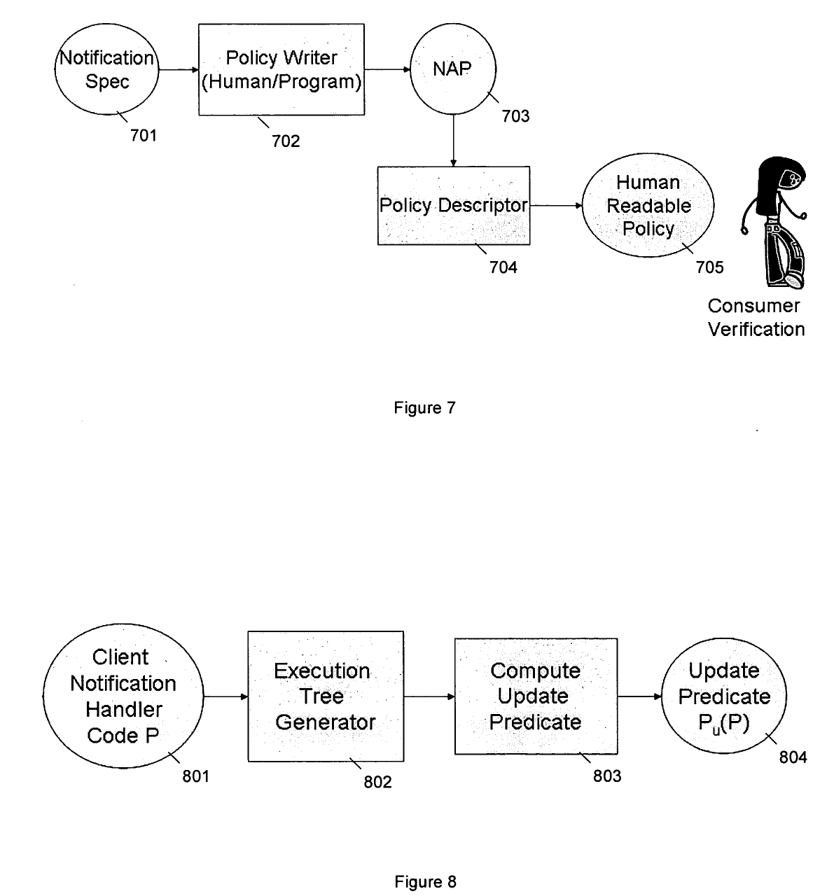

FIG. 7 illustrates a consumer process for verifying a client NAP generated by 3^{rd} parties (e.g., domain experts, GUI driven programs, etc.). This verification occurs before installation as a NAP.

Referring to FIG. 7, given a notification specification 701, the 3^{rd} party uses the policy constructors in notification specification 701 to generate various policies using policy writer 702. An intermediate NAP 703 is generated and in one embodiment is expressed entirely in terms of policy constructors available in notification specification 701. A policy descriptor module 704 describes to the consumer what the intended NAP would do. In one embodiment, policy descriptor module 704 uses the natural language descriptions of the policy descriptors to describe to the consumer what the intended NAP would do. Thus, policy descriptor module 704 generates and outputs human readable policy 705. Using human readable policy 705, the consumer reads the description of the NAP, and confirms that this is the NAP that is wanted. In one embodiment, only policy descriptor module 740 is trusted, with all other 3^{rd} parties potentially being malicious. Thus, the presence of policy constructors makes it possible to encode client intent unambiguously in terms of the functions of the underlying notification specification.

Static Verification and Dynamic Instrumentation of NAP

FIG. 8 illustrates one embodiment of a process for statically verifying a NAP. In one embodiment, this process is performed by code verification and instrumentation unit 102 of FIG. 1. Referring to FIG. 8, given client notification handler code (program P) 801, an execution tree generator 802 generates an execution tree for program 801. In one embodiment, nodes in an execution tree correspond to individual commands in the program, and the children of a particular node n are the commands that may be executed directly after the command corresponding to n. Thus, the execution tree defines a set of disjoint execution traces for program P. For each such trace t, a computation unit 803 calculates the “update predicate” Pᵤ(t). In one embodiment, the update predicate Pᵤ(t) has the property that it is true iff the function process_notif is called in this particular execution trace t of P. In one embodiment, the update predicate for the entire program P is the logical disjunction of all the update predicates for traces of P. This update predicate is denoted by Pᵤ(P).

In one embodiment, the update predicate operates on a trace of commands. The update predicate computation for a trace is given below and is computed by induction on the structure of commands.

| | |
|---|---|
| Pᵤ (process_notif, U) | = U |
| Pᵤ (Cmd₁; Cmd₂, U) | = Pᵤ (Cmd₁, Pᵤ (Cmd₂, U)) |
| Pᵤ (f(LiteralList), U) | = U |

Pᵤ (if BoolCond then Cmd₁ else Cmd₂, U)

= BoolCond and U if we're on “Yes” branch
of if

Pᵤ (if BoolCond then Cmd₁ else Cmd₂, U)

| | |
|---|---|
| | = not BoolCond and U if we're on “No” |
| | branch of if |
| Pᵤ (Var [symbol] Term, U) | = U [Var [symbol] Term] |

In one embodiment, the function definitions can be ignored for purposes of static verification because function definitions don't appear in execution traces, only function calls do. Notice that update predicate computation is similar to a weakest precondition computation starting from the node in the execution tree when process_notif is first called. The update predicate keeps incrementally evaluating the predicate as it moves through the commands in the trace. In order to compute the update predicate for a program P, the following is computed: Pᵤ (P, true). Note that U [Var←Term] denotes substitution of all occurrences of Var in predicate U by Term.

Given the update predicate (e.g., U) for a client notification handler, and given that the policy predicate in the NAP is P, the safety verification problem reduces to proving that P [symbol] U, P→ U or U→ P, corresponding to the logical connective in the original NAP. This ensures that the client code only handles the notifications that are allowed by the NAP. In case this proof fails, then the proof failure can guide dynamic insertion of checks into the client code so as to ensure that the update predicate for the resulting code will provably satisfy the required logical relationship with the policy predicate in the NAP.

In the event that the NAP is of form where handler code will be invoked only if the policy predicate P in the NAP is true, the entire handler code can be dynamically instrumented by wrapping it with the computational version of P. This computational version is directly accessible from the notification specification.

NAP Verification Examples

In two examples below, a consumer picks up a coupon for restaurant R (A), and then instructs the coupon server to send it coupons for any branch of that restaurant whenever it is within close range. In order to do so, the consumer interacts both with the coupon server and the map server.
1) High level human readable NAP (implicit policies unextracted): if it is close to lunch time, and if I'm close to the restaruant R, send me the direction to R.
2) Low level human readable NAP (implicit policies extracted): if current time is within 30 minutes to lunch time, and if I'm within 5 miles to the restaurant R, send me the direction from current location to R.

The definitions below capture the relevant portions of datatype specifications.

Definitions:

Types:

| Time (Var v) | # given a time is 10:15, v = 10 × 60 + 15 = 615 | |
|---|---|---|
| Location (Var lat, Var long) | # location latitude, longitude | |
| Region (Location loc, Var var) | | # Region of within a var-mile radius |
| Duration (Time t, Var var) | # duration of (time − var-minute) to time | |
| Coupon ( Var, Location) | | # coupon ID and location of store/restaurant |
| Literals: | | |

| | |
|---|---|
| T_{c}: Time | # current time |
| Tₗ: Time | # lunch time |
| L_{c}: Location | # current location |
| Lᵣ: Location | # location of restaurant |
| R_{c}: Region | # region defined as physically close |
| D_{c}: Duration | # duration defined as temporarily close |

Functions (Commands):
Location get_current_location(void)
Time get_current_time (void)
Bool is_within_duration(Time, Duration)
Bool is_within_region (Location, Region)
Void process_notif( )
Void ignore_notif( )
Void main_exec( )

An Example of Good Code:

| | # main function |
|---|---|
| L1: | void main_exec (void){ |

| | | |
|---|---|---|
| L2: | Duration D_{c} = (Tₗ, 30); | # define duration close to lunch time |

| L3: | Region R_{c} = (Lᵣ, 5); # define region close to restaurant | |
|---|---|---|
| L4: | Location L_{c} = get_current_location( );# get current location | |
| L5: | Time T_{c} = get_current_time( ); | # get current time |
| L6: | if ( is_within_duration(T_{c}, D_{c}) ) | |

| | |
|---|---|
| L7: | then if ( is_within_location(L_{c}, R_{c}) ) |

| | |
|---|---|
| L8: | then process_notif( ); |

| | |
|---|---|
| L9: | else ignore_notif( ); |

| | |
|---|---|
| L10: | else ignore_notif( ); |

| L11: | } |
|---|---|
| | # Function Definition |
| L12: | Bool is_within_duration (Time t, Duration d){ |

| | |
|---|---|
| L13: | if (t >= d.t − d.v && t <= d.t) |

| | |
|---|---|
| L14: | then return True; |

| | |
|---|---|
| L15: | else return False; |

| L16: | } |
|---|---|
| | # Function Definition |
| L17: | Bool is_within_region (Location l, Region r){ |

| | |
|---|---|
| L18: | if ( (r.loc.lat − l.lat)\hat{ }2 + (r.loc.long − l.long)\hat{ }2 <= r.var\hat{ }2 ) |

| | |
|---|---|
| L19: | then return True; |

| | |
|---|---|
| L20: | else return False; |

| | |
|---|---|
| L21: | } |

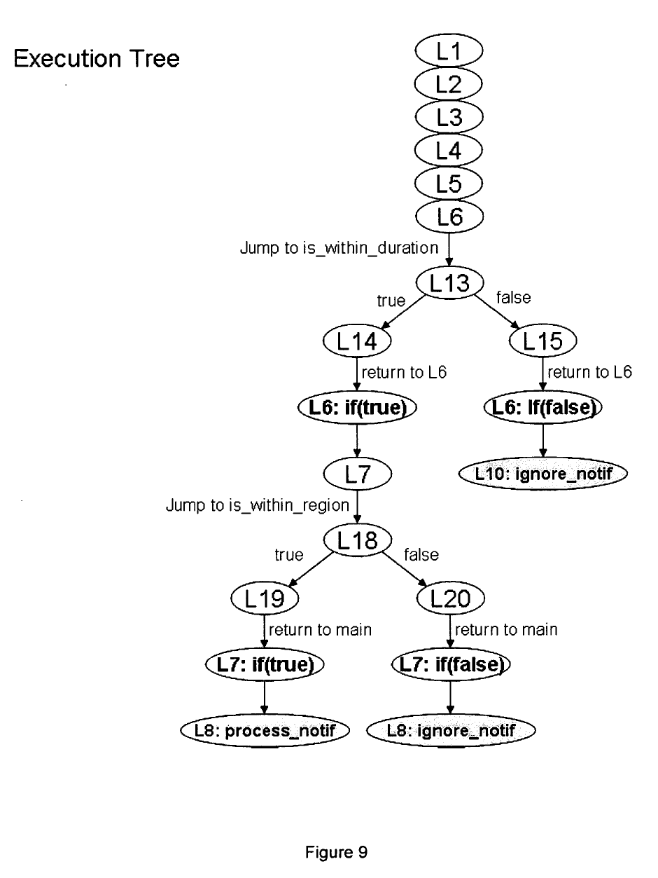

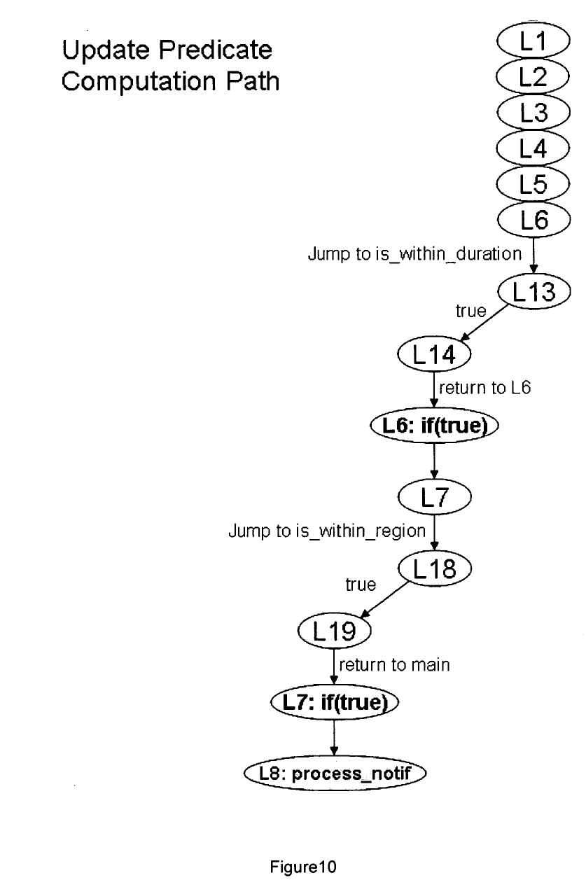

FIGS. 9 and 10 show the execution tree, and the portion of it that handles the computation of the update predicate.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving a notification; and
handling the notification safely using program code that has a notification handler that has been statically verified to handle the notification according to a notification acceptance policy.

2. The method defined in claim 1 wherein the notification handler has been dynamically instrumented with dynamic checks to conform to the notification acceptance policy if the program code, prior to receiving the notification, was determined to be unable to handle notifications safely.

3. The method defined in claim 1 wherein the notification policy is specified algebraically.

4. The method defined in claim 1 wherein the notification policy specifies that the handler processes the notification based on its type and a policy predicate.

5. The method defined in claim 4 wherein the policy predicate is constructed from policy constructors specified in a specification for the notification with the same notification type.

6. The method defined in claim 1 wherein the notification acceptance policy is generated by another party, and further comprising verifying the notification acceptance policy prior to its use in handling the notification.

7. The method defined in claim 6 wherein verifying the notification acceptance policy comprises generating one or more policies using a notification specification and using a natural language description of policy descriptors to describe how the notification acceptance policy would operate.

8. The method defined in claim 1 further comprising performing static verification of the program code corresponding to the handler by:
generating an execution tree for the program code, where nodes in the execution tree correspond to individual commands in the program code; and
computing an update predicate for portions of the program code in which notifications are accessed.

9. The method defined in claim 1 further comprising checking a notification handler in the program code for safety compliance with the notification acceptance policy.

10. The method defined in claim 1 wherein the notification acceptance policy is specified by a consumer of the notifications.

11. The method defined in claim 1 wherein the unsolicited notification is specified as a first class data object.

12. The method defined in claim 1 wherein at least one of the first class data objects includes a specification indicating how the one first class data object may be computed upon and how the one data object may be used in a policy in the notification policy.

13. The method defined in claim 1 wherein at least one policy for safe handling of notifications in the set of one or more policies is specified as a Notification Acceptance Policy (NAP).

14. The method defined in claim 1 wherein the notification is sent from a server to a client executing the program code that has the notification handler.

15. The method defined in claim 1 wherein the notification in sent in response to a request from a client executing the program code.

16. The method defined in claim 1 wherein the notification in sent in response to a request from a first client that is different from a second client executing the program code.

17. The method defined in claim 1 wherein the notification in sent in response to an inter-server communication.

18. An article of manufacture having one or more computer readable storage media storing instructions thereon which, when executed by a system, cause the system to perform a method comprising:
receiving a notification; and
handling the notification safely using program code that has a notification handler that has been statically verified to handle the notification according to a notification acceptance policy.

19. The article of manufacture defined in claim 19 wherein the notification handler has been dynamically instrumented with dynamic checks to conform to the notification acceptance policy if the program code, prior to receiving the notification, was determined to be unable to handle notifications safely.

20. The article of manufacture defined in claim 19 wherein the notification policy is specified algebraically.

21. The article of manufacture defined in claim 19 wherein the notification policy specifies that the handler processes the notification based on its type if a policy predicate is in a predetermined logical state.

22. The article of manufacture defined in claim 21 wherein the policy predicate is constructed from policy constructors specified in a specification for the notification with the same notification type.

23. The article of manufacture defined in claim 19 wherein the method further comprises verifying the notification acceptance policy by generating one or more policies using a notification specification and using a natural language descriptions of policy descriptors to describe how the notification acceptance policy would operate.

24. The article of manufacture defined in claim 19 wherein the method further comprises performing static verification of the program code corresponding to the handler by:
generating an execution tree for the program code, where nodes in the execution tree correspond to individual commands in the program code; and
computing an update predicate for portions of the program code in which notifications are accessed.

25. A method comprising:
performing static verification on program code that handles a notification, wherein the static verification is performed according to a notification acceptance policy;
dynamically instrumenting the program code with dynamic checks to conform to the notification acceptance policy if the program code, prior to receiving a notification, is determined to be unable to handle notifications safely;
receiving a notification;
executing a program that includes a handler to handle the notification safely according to the notification acceptance policy.

26. The method defined in claim 25 wherein the notification policy is specified algebraically.

27. The method manufacture defined in claim 25 wherein the notification policy specifies that the handler processes the notification based on its type and a policy predicate.

28. The method defined in claim 25 wherein the policy predicate is constructed from policy constructors specified in a specification for the notification with the same notification type.

29. The method defined in claim 25 further comprising verifying the notification acceptance policy by generating one or more policies using a notification specification and using natural language descriptions of policy descriptors to describe how the notification acceptance policy would operate.

30. The method defined in claim 25 further comprising performing static verification of the program code corresponding to the handler by:
generating an execution tree for the program code, where nodes in the execution tree correspond to individual commands in the program code; and
computing an update predicate for portions of the program code in which notifications are accessed.
